(19) United States
(12) Patent Application Publication
(10) Pub. No.: US 2014/0278794 A1
(43) Pub. Date: Sep. 18, 2014

(54) Systems and Methods for Interfacing an Electrical Energy End User with a Utility

(71) Applicant: Open Access Technology International, Inc., Minneapolis, MN (US)

(72) Inventors: Ilya William Slutsker, P:lymouth, MN (US); Sasan Mokhtari, Eden Prairie, MN (US); Walter Lee Kalsow, Dayton, MN (US); Jose Medina Palomo, Minneapolis, MN (US); Isaiah Olanrewaju Oloyede, Burnsville, MN (US); Jaspreet Singh, Rogers, MN (US)

(73) Assignee: Open Access Technology International, Inc., Minneapolis, MN (US)

(21) Appl. No.: 14/216,234

(22) Filed: Mar. 17, 2014

Related U.S. Application Data
(60) Provisional application No. 61/792,753, filed on Mar. 15, 2013.

(51) Int. Cl. G06Q 30/02

(52) U.S. Cl. CPC G06Q 30/0203
USPC 705/7.32

(57) ABSTRACT

A system and method which allows end users of electrical energy to engage in, comply with, and otherwise make use of a smart grid program. The invention allows end users to engage with an entity running a smart grid program through such actions as sending notifications, agreeing to events, paying bills, reviewing contracts, and updating information. The invention receives data from and sends messages to any smart meters, AMI or HAN, the end user has in their service location necessary to comply with the smart grid program. The invention supports the use of any smart meters the end user employs for home automation network functionality, enabling the end user to activate, deactivate, or otherwise modulate any devices enabled with a smart meter at their service location. The invention receives data from and sends messages to any demand response system the entity running the smart grid program employs to support the smart grid program.

### CROSS-REFERENCE TO RELATED APPLICATIONS

This application claims priority to U.S. Provisional patent application No. 61/792,753 filed Mar. 15, 2013, the entire content of which is hereby incorporated by reference.

Applicant has other co-pending applications directed to the energy market, namely:

SYSTEMS AND METHODS FOR DEMAND RESPONSE AND DISTRIBUTED ENERGY RESOURCE MANAGEMENT, filed Feb. 9, 2011 and assigned application Ser. No. 13/024,158, the entire contents of which is hereby incorporated by reference.

AUTOMATION OF ENERGY TRADING, filed Dec. 30, 2011 and assigned application Ser. No. 13/140,248, the entire contents of which is hereby incorporated by reference.

CERTIFICATE INSTALLATION AND DELIVERY PROCESS, FOUR FACTOR AUTHENTICATION, AND APPLICATIONS UTILIZING SAME, filed Oct. 15, 2013 and assigned application Ser. No. 14/054,611, the entire contents of which is hereby incorporated by reference.

A renewable energy credit management system and method, filed Feb. 10, 2014 and assigned application Ser. No. 14/176,590, the entire contents of which is hereby incorporated by reference.

Systems and methods of determining optimal scheduling and dispatch of power resources, filed on Mar. 17, 2014 (Docket No. O17.2P-15315-US03), the entire contents of which is hereby incorporated by reference.

Systems and methods for managing energy generation and procurement, filed on Mar. 17, 2014 (Docket No. O17.2P-15469-US03), the entire contents of which is hereby incorporated by reference.

Systems and methods for tracing electrical energy of a load to a specific generator on a power grid, filed on Mar. 17, 2014 (Docket No. O17.2P-15493-US03), the entire contents of which is hereby incorporated by reference.

Systems and methods for trading electrical power, filed on Mar. 17, 2014 (Docket No. O17.2P-15565-US03), the entire contents of which is hereby incorporated by reference.

Systems and methods for managing conditional curtailment options, filed on Mar. 17, 2014 (Docket No. O17.2P-15571-US03), the entire contents of which is hereby incorporated by reference.

Systems and methods for tracking greenhouse gas emissions, filed on Mar. 17, 2014 (Docket No. O017.2P-15954-US02), the entire contents of which is hereby incorporated by reference.

Systems and methods for parameter estimation for use in determining value-at-risk, filed on Mar. 17, 2014 (Docket No. O17.2P-15955-US02), the entire contents of which is hereby incorporated by reference.

Systems and methods for managing transmission service reservations, filed on Mar. 17, 2014 (Docket No. O17.2P-15956-US02), the entire contents of which is hereby incorporated by reference.

Use of Demand Response (DR) and Distributed Energy Resources (DER) to mitigate the impact of Variable Energy Resources (VER) in Power System Operation, filed on Mar. 17, 2014 (Docket No. O17.2P-15959-US02), the entire contents of which is hereby incorporated by reference.

### STATEMENT REGARDING FEDERALLY SPONSORED RESEARCH

Not Applicable

### FIELD OF THE INVENTION

The present invention relates generally to a customer portal for energy Demand Response (DR) customer engagement. Customer engagement includes DR events, DR performance, available DR Programs, enrollment within said programs, and DR asset pages.

### BACKGROUND OF THE INVENTION

There is an increasing desire and ability to create a more integrated and purposeful energy production, transmission, and consumption system. This all-encompassing effort is often referred to as a “Smart Grid.” There are numerous efforts which must succeed simultaneously and independently for such an effort to succeed as a whole, one of which must fall upon the final consumer. The final consumer of energy must agree upon and follow through with any Smart Grid system. The final user of energy is the only element in the chain for whom energy is not their literal business, and garnering dependable participation of the final user is in some ways the most vexing step. This makes it crucial that the final user is engaged in a manner which is as simple yet powerful as possible.

Currently available systems, however, do not lend themselves to simple end-user participation. The current state of the industry often requires users to blindly sign into a DR program offered by a program provider (Program Provider) or to research independently to find Smart Grid systems, sign up for any such systems with a manual effort, track upcoming events independently or with a disconnected tool, and be without a comprehensive tool to sign up for, engage in, and track their smart grid activities. This means that for a customer to actively participate in the Smart Grid they must make dramatic independent and often manual efforts to do so. These efforts are also outside of any standard efforts or communications which the customer would have with the Program Provider, which means that any Smart Grid effort would not dovetail with their energy payment/enrollment/tracking mechanisms, but would instead require an entirely new effort.

On top of this, there is also a growing push for home area network (HAN) systems and controls. Most of these systems are stand-alone systems which do not serve any purpose or assist in any effort besides home automation. Despite the fact that a customer's need to interact with Program Providers, a customer's desire to automate their home, and a customer's potential to participate in Smart Grid all operate on the same technological plane, at this point each prong requires efforts independent of the other.

The art referred to and/or described above is not intended to constitute an admission that any patent, publication or other information referred to herein is “prior art” with respect to this invention. In addition, this section should not be construed to mean that a search has been made or that no other pertinent information as defined in 37 C.F.R. §1.56(a) exists.

All U.S. patents and applications and all other published documents mentioned anywhere in this application are incorporated herein by reference in their entirety.

Without limiting the scope of the invention, a brief summary of some of the claimed embodiments of the invention is set forth below. Additional details of the summarized embodiments of the invention and/or additional embodiments of the invention may be found in the Detailed Description of the Invention below.

A brief abstract of the technical disclosure in the specification is provided for the purposes of complying with 37 C.F.R. §1.72.

### BRIEF SUMMARY OF THE INVENTION

The inventive system and methods described herein and sometimes referred to as webSmartView Demand Response Portal (webSmartView) provide a portal thr such activities as DR customer engagement. The portal will be available on such devices as laptops, desktops, mobile phones, or other mobile devices. DR customer engagement comprises DR Events, DR performance, available DR Programs, enrollment, and DR asset pages. This functionality provides a service with the ability for Program Providers to integrate it with their existing portal using a log-in page.

For DR engagements the functionality will provide, among other things, a list of the available DR Programs from the Program Provider for the retail customer, a list of the DR Events in which the retail customer is a participant, an entry screen for the retail customer to submit a request to enroll in a particular DR Program, the capability for end consumers to view and adjust opt-in/opt-out DR devices, the ability for customers to adjust devices from the Demand Response Portal, the capability for customer to see/manage/pay their bill, and the ability to see in real-time what their energy consumption is.

For customer-enrollment functionality, the customer may be presented with a selection of programs for which they are eligible to enroll based upon the customer's class.

For DR events, the customer may be presented with a scrollable list with the most recent DR Events for which their devices have participated.

### BRIEF DESCRIPTION OF THE SEVERAL VIEWS OF THE DRAWINGS

The present invention will be explained in more detail below by means of drawings.

FIG. 1 Flow of Data between webSmartView and Utility

FIG. 2 Flow of Data between webSmartView and Devices

FIG. 3 Flow of Data between webSmartView and Customer

FIG. 4 is a block diagram illustrating a computer system that may be utilized in the performance of the disclosed system and methods/processes.

### DETAILED DESCRIPTION OF THE INVENTION

While this invention may be embodied in many different forms, described in detail herein are specific preferred embodiments of the invention. These descriptions are exemplifications of the principles of the invention and are not intended to limit the invention to the particular embodiments illustrated.

For the purposes of this disclosure, like reference numerals in the figures shall refer to like features unless otherwise indicated.

In some embodiments, the Demand Response Portal is enabled for customer 306 use by setting up data conduits to and from the Demand Response Portal and various external systems. In one embodiment the Demand Response Portal may be activated with a Program Provider 101 enabling Application Programming Interfaces (API) between the Demand Response Portal and the Program Provider's existing online systems. Program Providers are usually electrical utilities, but they may also be reliability operating entities, transmission and distribution system operators, regional transmission operators, or independent system operators and their representatives. With these APIs the Demand Response Portal may be enabled to take data from the Program Provider and send data to the Program Provider. The invention may then be given access to the Program Provider's 101 existing online database via API. The Demand Response Portal may be enabled to pull customer information 104 such as but not limited to addresses 104, names 104, energy consumed 204, and billed amount 103 from the Program Provider 101. The Demand Response Portal may also be given access to the Program Provider's existing Smart Grid meter management system (Meter Management Tool) and or demand-response management tool 206 (DR Management Tool). At this point databases may be enabled to take data from the DR Management/Meter Management Tool 206 and to the DR Management/Meter Management Tool 206. The Demand Response Portal may pull data pertaining to Smart Grid programs 106 and display the details behind these programs 106, such details including but not necessarily limited to, where the programs 106 are offered, the kWs which must be reduced, how many annual events would be necessary per program, and the cost savings per event. In one particular embodiment the Demand Response Portal requires two-way data flow to be enabled between the Demand Response Portal 112 and both of the Program Provider 101 and a DR Management Tool 206. In one particular embodiment enabling this data flow may result in full availability of the Demand Response Portal. In one particular embodiment, the portal may be hosted on the website of the Program Provider 101.

The invention will enable the customer portal 112 for the user's mobile device on numerous operating systems, such as but not limited to Android and iOS compatible mobile smart phones. The customer portal accessible via mobile device allows customers to have remote access to their energy information from anywhere a cellular data connection is available. This may further empower Smart Grid users by providing the ability to change their home energy usage on demand. By delivering real-time information to the smartphone, customers have an ability to understand and react to the current state of their residence, both for purposes of managing their DR events and also for generally managing their residence. Moreover, when on mobile phones, users 306 will have an option on the mobile phone to call the Program Provider 101. This action may be performed with a single button which will bring up the number for appropriate Program Provider 101 representative for the situation and activate any calling function which the devices possesses.

In preferred embodiments all information flow will be preconditioned on secure identification and encrypted transmittals. In some particular embodiments the invention may utilize encryption enabling software, such as but not necessarily limited to digital certificates, to secure access to the online portal and encrypt communications sent to and from the Demand Response Portal. Using any number of methods known in the art, the Demand Response Portal may require and validate for the presence of specific encryption enabling software as a login credential. In preferred embodiments, such encryption enabling software is associated on a one-to-one basis with a particular user account. Login to the system of such embodiment would be denied unless the system authenticates, using any method known in the art, that a user's request to access the system includes the correctly corresponding login credentials comprising of username, password, and encryption enabling software, among others, associated with a particular predefined user account. Moreover, in other embodiments, encryption enabling software may be utilized to encrypt data communications within the Demand Response Portal or between the Demand Response Portal and other systems.

Moreover, communications between the Demand Response Portal and other systems may also be encrypted with encryption enabling software. Such encryption can be accomplished using any known means available in the art. As a non-limiting example, both the system of the present disclosure and a destination system can be set up with encryption enabling software, such as but not necessarily limited to digital certificates, to facilitate the encryption of communication sent from one system and the subsequent decryption of the information by the recipient system. Such pre-incorporation of encryption enabling software by both the sending system and recipient systems ensures that any intercepted communications cannot be read, thus raising the confidence level of commands, messages, and transmittals occurring within the system as a whole.

The Demand Response Portal may act to gain sufficient customer information 104 to enable smart grid participation for a particular customer 306. In one particular embodiment, this process may be triggered by a customer 306 requesting information about Smart Grid participation from the Demand Response Portal. In another embodiment, the customer 306 gains access to the Demand Response Portal by requesting information about or participation in the Program Provider's Smart Grid programs. In one embodiment, this line of inquiry may ultimately direct the customer 306 to the Demand Response Portal 112. In an embodiment wherein the customer 306 has already logged in on the Program Provider's website as a unique user, such unique user having been pre-associated with the user 306 by the Program Provider 101, customer information 104 as necessary to support the customer for their use of the online portal may automatically transfer into the Demand Response Portal via the aforementioned API between the Program Provider 101 warehouse of data and the Demand Response Portal. In an embodiment wherein a customer 306 has not signed in prior to arriving at the Demand Response Portal 112, the customer 306 may be asked to give sufficient identification information or credentials 104, such as the customer's Program Provider account number or their name and address, as may be required to identify and authenticate the user prior to system login. Upon login, the Demand Response Portal may simultaneously or in short order then go through the API and gather customer information 104 as necessary to support the customer for their use of the online portal. At this point databases may be enabled to take data from the customer 306, to the customer 306, or both.

A utility 101 may pre-configure programs offered by said Program Provider 101 and supported by a DR Management Tool 206 to apply only to customers with specific characteristics. The Demand Response Portal 112 may identify whether or not the customer 306 is a residential customer or a commercial/industrial (C&I) customer through the customer information 104 supplied via the API to the utility 101. The Demand Response Portal may also determine customer 306 type configuration (residential or C&I) from customer information 104 inputted directly by the customer 306 in the Demand Response Portal. The Demand Response Portal may take customer information 104 and reference it against a database maintained by the Program Provider 101 which identifies all customers as a particular classification (residential or C&I). The Demand Response Portal would reference said Program Provider 101 database via a query sent through the API, and then associate the customer 306 linked with said customer information 104 as identified classification. Another option that the Demand Response Portal may support is to take the customer information 104 and reference it against a database maintained by the Program Provider 101, which specifies certain customer locations as a particular classification (residential or C&I). The Demand Response Portal would reference said Program Provider 101 database via a query sent through the API, and then associate the customer 306 located at said location as identified classification.

The Demand Response Portal may then take this classification to identify to the customer 306 what programs 106 are available. This may be done by taking the classification and the customer location and referencing these against a database which identifies which programs 106 are available to certain customer classifications at certain locations. This database would be maintained and updated on the Program Provider 101 server but imported to the Demand Response Portal via API. Based upon the customer classification and location, the Demand Response Portal 112 would display the programs 106 are available to the customer 306. This functionality may be available to all users, regardless of variety of device used to access the customer portal.

The Demand Response Portal 112 may then display these programs 106 and the characteristics of these programs 106 to the customer 306. These programs 106 might differ by such characteristics as the number of times 105 during a given time period the customer 306 can be expected to engage in an alteration of energy consumption patterns (such an occurrence hereinafter referred to as an Event), the number of Events the customer is permitted to opt out of, the rebate the customer can expect by enrolling, the timing of these Events 105, the mechanism by which the Event can happen or any other number of factors. The Demand Response Portal may allow the customer 306 to sort the programs 106 by type, allowing the customer 306 to display those programs 106 with the most savings on top or those programs 106 with the least amount of Events on two, to list two examples. This functionality would be available to all users, regardless of variety of device used to access the customer portal.

The Demand Response Portal may then enable the customer 306 to select and enroll 107 in any of the programs 106 they are eligible for. If the customer chooses to enroll in any program 106, they may immediately be directed to any forms which they must fill out to gain participation, all of which may be completed directly on the Demand Response Portal. Such selection, enrollment 107, and completed forms can be communicated to the utility 101 via an API interface. This functionality would be available to all users, regardless of variety of device used to access the customer portal.

A baseline energy usage 202 (Baseline) may then be established for each customer 306. The Baseline 202 is the standard energy usage 204 of the customer 306 and is used to help track compliance of the customer. A residential customer may not have an individual Baseline 202 created for them; a statistical customer Baseline 202 based on the customer's house size and premise type (e.g. apartment, duplex, single family home, etc.) which displays different loads for each day of the week may be used instead. A customer may view their Baseline 202 at any time.

The Demand Response Portal also allows for numerous mechanisms by which a customer 306 can be notified for Events 302. In one particular embodiment, notifications 302 may originate from the DR Management Tool 206. These notifications 302 may display on the Demand Response Portal 112 and can be further disseminated over mediums such as but not necessarily limited to email, phone call, text messages, fax, or HAN 207 devices 208. A customer 306 may configure options within the Demand Response Portal to specify a method of notification 302 dissemination. The Demand Response Portal may include functionality for the customer 306 to select any such communication options and communicate such selection to the DR Management Tool 206 or other such source of the notification 302.

The content of the notification may be dictated by the nature of the Event. For example, if the Event is for residential customers, the notification may state the day and time of an Event and state how much power the customer may be limited to for that Event. A notification may also state how much power a utility would draw from a customer, granted that the customer had generation capability. For example, if the customer 306 is a C&I customer, the notification may detail the specific amount of energy which the customer 306 would be expected to curtail. A C&I customer may have numerous locations which independently draw a notable amount of energy. Each location can have a separate program 106 in which that location is enrolled. Depending on the customer's program/agreement, the customer 306 may independently receive notifications of Events 302 for each location, and must therein independently acknowledge these notifications 302 through any means known in the art. As another example, if the customer 306 is a residential customer, the notification 302 may describe the general ramifications the customer 306 could be expected to experience (e.g. the customer 306 may not be able to run their air conditioner/dishwasher/drying machine, etc.) on a specific day. The customer 306 may also receive an alert as soon as the customer 306 initializes the Demand Response Portal for new notifications 302. The Demand Response Portal may allow a customer 306 to view old alerts, if they so desire. This functionality would be available to all users, regardless of variety of device used to access the customer portal.

The Demand Response Portal enables customers 306 to respond to notifications 302 in various manners. Some programs may allows customers 306 to opt out of certain Events. The Demand Response Portal may facilitate such opting out by enabling the customer 306 to state whether or not they will comply while the customer 306 acknowledges the notification 302. In some embodiments of the invention, if a customer 306 cannot reduce their load by the full requested energy amount, the Demand Response Portal may facilitate the customer 306 to counteroffer with a lesser amount to the Program Provider, which the Program Provider can agree to and provide a new notification in regards to. Some notifications 302 do need to be acknowledged; if the customer is a residential customer they are expected to comply with Events 302, though the customer 306 may opt out a certain number of times as dictated in the terms of the program 106 and still receive the benefits of the program 106. In some embodiments of the invention, a residential customer may also specify which devices will be curtailed to make the curtailment necessary to satisfy the Event, granted that such devices are enabled for such specified curtailment. The Demand Response Portal 112 may keep a log of various event performance 203 data, including but not limited to how many times the customer 306 has been notified of Events 302, how many Events 302 said customer has opted out of 304, and how far away the customer 306 is from said customer's contractual quota, if applicable. The Demand Response Portal may also display a non-performance alert to a customer 306 if said customer is a C&I customer and has informed the Program Provider that they may comply but then do not appear to be based upon metrics as pre-configured with a DR Management Tool 206 and as communicated to the invention by such DR Management Tool 206. This functionality would be available to all users, regardless of variety of device used to access the customer portal.

In order to satisfy an Event 302, the customer 306 can go to a device summary screen to manage their devices 208. The user can enter every energy-using device (Device) 208 which they have configured to the DR Management Tool 206 and HAN 207 into the Demand Response Portal. This may be done by going to the aforementioned device summary screen, clicking on the option for a new device option, titling the new device option, and linking this new device option to the feed associated with this device from the DR Management Tool 206 and/or HAN 207. This feed can be navigated to and selected from this device summary screen. In one particular embodiment, configuring a new device option in the DR Management Tool 206 and/or HAN 207 may automatically create a prompt in the Demand Response Portal to create a new device option on the device summary screen. The customer can then select this Device 208 on the Demand Response Portal and send a command 305 through the Demand Response Portal to turn the Device off. The Demand Response Portal 112 may then communicate 205 via web services with the HAN 207 or Advanced Metering Infrastructure (AMU system, which may then send a signal to the Device 208, which may turn the Device 208 off or otherwise modulate the Device 208. In this way the customer can sign up through an agreement 106 for a program 106, receive nonce of an Event 302, and comply 303 with a program 106 Event 302 all from one interface.

A customer 306 may also take numerous actions in regards to their bill 103. In certain embodiments of the invention where the Program Provider is an electrical utility, a customer may set monetary or energy goals for themselves on the Demand Response Portal 112, may pay 102 any bill 103 to the Program Provider 101 on the Demand Response Portal 112, and may compare their current bills 103 to their goals as well as the standard bill 110 for their customer type, both in terms of energy used 204 and money spent 102. A customer 306 may also track how close/far from their goal they are throughout their bidding cycle, on that they know whether they need to change their energy-consumption habits in order to meet their goal. If the customer 306 has added any devices 208, the Demand Response Portal 112 can even tell the customer 305 which devices 208 the customer 305 could adjust and in what ways in order to meet the goal. The Demand Response Portal may tell the customer 306 in real time the energy being used 204, and how energy usage changes with different device configurations at different times. The Demand Response Portal may also show the customer what these configurations would mean in terms of energy used 204 and money owed 103 when extrapolated across an entire billing cycle. This functionality would be available to all users, regardless of variety of device used to access the customer portal.

The Demand Response Portal can also serve as a general IAN 207 portal for the customer. If the customer has appropriately enabled all of their devices, they may be able to see any device they want within their location and can deactivate or modulate any of these devices. This can be used to satisfy Events, change energy usage, or simply to remotely run a home. Being as the invention can be enabled for as many computers as a customer requires and is even available as a mobile phone application, this means that a customer can even satisfy Events when they are away from their home on vacation or check if an oven is off or verify that an air conditioner is turning on while away from their home at the office.

In one particular embodiment where the Program Provider is an electrical utility, the Demand Response Portal 112 may also be able to display different options for tariffs 108. There are often different options for tariffs 108 available to a given customer 306. The effects of these tariffs 108 may be difficult to envision for a standard customer 306, so the Demand Response Portal 112 may be able to help a customer 306 investigate a potential tariff 108 by showing the customer 306 what a bill 103 would look like, given the customer's 306 standard energy usage 204. The Demand Response Portal may also be able to show a customer how a given tariff 108 may be optimized, given the customer's baseline and enabled HAN devices, if any. If the customer then wishes to change their tariff 108 the Demand Response Portal 112 may allow the customer to do so by selecting a “change my tariff” option on the tariff presentation page. Selecting this option would have the customer fill out any necessary forms or paperwork on the Demand Response Portal, which the Demand Response Portal would then send back to the Program Provider 101 via API for processing. This functionality may be available to all users, regardless of variety of device used to access the customer portal.

A customer 306 may also perform various standard account management activities using the Demand Response Portal. In some embodiments, a customer 306 may generally customize the colors, fonts, and display arrangements of the Demand Response Portal's user interface. In one embodiment, the Demand Response Portal may enable a customer 306 to update the customer's information 104 which the customer's utility 101 would have on file. In one particular embodiment, a customer 306 could update their information by accessing a page entitled “My Information” and selecting an “edit” option, which would change all of the fields from presented fields to editable fields. Changing or adding to any said editable would result in customer information 104 being sent back to the Program Provider 101 via API. This functionality would be available to all users, regardless of variety of device used to access the customer portal.

The Demand Response Portal may support a customer 306 changing their customer information 104. If the customer information 104 which the customer 306 is changing is the address, the Demand Response Portal may ask the customer 306 if they are moving. If the customer 306 selects an option to specify that the customer 306 is not moving, the Demand Response Portal may seek to discover why the address is being changed, e.g. whether the address change was submitted in error, whether the address change was submitted to correct a prior clerical mistake, or whether it was done for any other reason. If the customer 306 selects an option to specify that the customer 306 is moving, the Demand Response Portal may check the new address to verify if said address can also be serviced by the customer's 306 current Program Provider 101 by using the API to the Program Provider's 101 warehouse to reference the Program Provider's service area. If the new address is not within the service area of the current Program Provider 101, the Demand Response Portal may so inform the customer 306, and also inform the customer 306 of any sister utilities which the current Program Provider 101 may be associated with which can service the new customer 306 location. At this point the Demand Response Portal may also direct the customer 306 to fill out all necessary “end of service” paperwork and potential “new service” paperwork to sister Program Provider, either of which would then be sent via API to the current Program Provider 101. If the customer 306 is going to be staying within the service area of the Program Provider 101, the Demand Response Portal may verify whether or not the same programs 106 or tariffs 108 are available at the new location. Such verification may be performed by the invention by referencing the classification and new customer location against the Program Provider 101 database which identifies which programs 106 are available to which customer varieties in which locations. Said database would be maintained and updated on the Program Provider 101 server but imported to the Demand Response Portal via API. If the same programs 106 and tariffs 108 are available, the Demand Response Portal may ask the customer 306 if the customer 306 plans on staying in the customer's 306 current program 106 and the customer's 306 current tariff 108. If the same programs 106 and tariffs 108 are not available at the new location, the Demand Response Portal may present the customer 306 with the new programs 106 and tariffs 108 which are available in the new location which the customer 306 can choose from. Whether the customer chooses to stay with the customer's current program 106 and tariff 108 or choose a new program 106 and/or tariff 108, the Demand Response Portal may have the customer 306 fill out the proper paperwork and, upon completion of the paperwork, send all program 106 and tariff 108 agreements 107 to the Program Provider 101. This functionality would be available to all users, regardless of variety of device used to access the customer portal.

In some embodiments, the Demand Response Portal may enable a customer 306 to view documentation of their energy statement 213 from the Program Provider 101 whenever desired. This is possible through a screen which in some embodiments is entitled “My Records” from which the customer 306 can access all relevant documents. A customer 306 may also look up a record of the entirety of their agreement 107 in regards to the program 106 commitment, to see what the customer 306 can expect and what is expected of the customer 306. This may include a list of all Events 105 the customer 306 will need to complete in order to comply, the general nature of these Events, and the time existing on their contract. The Demand Response Portal may be configured to store any number of documents, as provided by a Program Provider 101 or other entity, in any known document format. Such documents may be stored within the invention through any means known in the art in order to enable customer 206 to select and view such documents. This functionality would be available to all users, regardless of variety of device used to access the customer portal.

Some or all of the previously discussed embodiments may be performed utilizing a computer or computer system. An example of such a computer or computer system is illustrated in FIG. 4. Computer 600 contains Central Processing Unit 601. Central Processing Unit 601 may perform some or all of the processes involved in the previously discussed embodiments. Central Processing Unit 601 may utilize information contained in Memory 602, Database 603, or both. Central Processing Unit 601 may also write information to Memory 602, Database 603, or both. While in this FIG. 4 only one Computer 600 is shown, some embodiments may make use of multiple computers, computer systems, or cloud-based computer system infrastructure. In some embodiments some of these computers or computer systems may not have dedicated memory or databases, and may utilize memory or databases that are external to the computer or computer system.

The above examples and disclosure are intended to be illustrative and not exhaustive. These examples and description will suggest many variations and alternatives to one of ordinary skill in this art. All of these alternatives and variations are intended to be included within the scope of the claims, where the term “comprising” means “including, but not limited to”. Those familiar with the art may recognize other equivalents to the specific embodiments described herein which equivalents are also intended to be encompassed by the claims. Further, the particular features presented in the dependent claims can be combined with each other in other manners within the scope of the invention such that the invention should be recognized as also specifically directed to other embodiments having any other possible combination of the features of the dependent claims. For instance, for purposes of written description, any dependent claim which follows should be taken as alternatively written in a multiple dependent form from all claims which possess all antecedents referenced in such dependent claim.

1. A system for interfacing an electrical energy end user with a Program Provider, comprising:
a computing device having a memory for running a program configured to:
provide demand response customer engagement.

2. The system of claim 1 wherein the demand response customer engagement utilizes a computer program.

3. The system of claim 2 wherein the computing device is selected from a group consisting of a computer, a laptop computer, a tablet computer, and a mobile phone.

4. The system of claim 1 wherein the Demand Response Portal displays the electrical energy end user's demand response performance.

5. The system of claim 1 wherein the Demand Response Portal displays all demand response events associated with the electric energy end user.

6. The system of claim 1 wherein the Demand Response Portal displays a list of all demand response programs available from the Program Provider.

7. The system of claim 6 wherein the program allows the electrical energy end user to enroll in available demand response programs.

8. The system of claim 1 wherein the Demand Response Portal displays all demand response devices.

9. The system of claim 1 further including accessibility to a Program Provider server from the computing device through the internet.

10. The system of claim 9 wherein the Program Provider server provides identifying and authenticating electrical energy end user information with which the Demand Response Portal identifies and authenticates the electrical energy end user.

11. The system of claim 10 wherein the program also provides the capability for the electrical energy end user to be identified and authenticated entirely within the Demand Response Portal.

12. The system of claim 1 wherein the program uses encryption methods for all system access and transmittals.

13. The system of claim 1 wherein the program also provides the capability for the end user to opt-in or opt-out of demand response events.

14. The system of claim 1 wherein the program also provides the capability for the end user to adjust demand response devices

15. The system of claim 1 wherein the program also provides the capability for the end user to view and pay their Program Provider bill.

16. The system of claim 1 wherein the program also provides the capability for the end user to see in real-time their energy consumption.

17. The system of claim 1 wherein the end user may view a scrollable list of the recent demand-response notifications which the end user has received.

18. The system of claim 1 wherein the end user has at least one smart meter and the system can interface with a Program Provider's smart meter management system.

19. The system of claim 18 wherein the program is further configured to act as a home area network (HAN) portal for the end user, to enable the end user to view all the HAN enabled devices the end user has at a location and deactivate or modulate any of the HAN enabled devices.

20. The system of claim 1 wherein the system can interface with a Program Provider demand response management tool.

21. A method of enabling end users of electrical energy to participate in Smart Grid programs, comprising the steps of:
establishing a new end user;
signing up an end user for a program;
sending an end user event notifications;
processing responses from the end user, and;
allowing end users to engage a program as a HAN.

22. The method of claim 21 further including the step of identifying and authenticating a user prior to system enablement.

23. The method of claim 22 further including the step of sending any identifying and/or authenticating information regarding the end user obtained by the Program Provider to the invention in the event that the user is uniquely identified and/or authenticated within a Program Provider system before being directed to the invention.

24. The method of claim 22 further including the step of sending such information to any computing device selected from a group consisting of a computer, a laptop computer, a tablet computer, and a mobile phone.

25. The method of claim 21 further including the optional step of changing programs or renewing program agreements.

26. The method of claim 21 further including the step of sending the notification to the user a method comprising phone calls, emails, text messages, and pop-ups.

27. The method of claim 21 further including the step of giving the end user options as to how to respond to notifications, such options comprising opting in, opting out, or counter-offering.

28. The method of claim 21 further including the step of the end user enabling any device the end user would like accessible in a program for HAN purposes.

29. The method of claim 21 or claim 24 further including the step of encrypting transmittals and securing program access with encryption enabling software.
